(19) United States
(12) Patent Application Publication
(10) Pub. No.: US 2024/0316853 A1
(43) Pub. Date: Sep. 26, 2024

(54) COMPONENT FOR MOTOR VEHICLE TANK

(71) Applicant: Plastic Omnium Advanced Innovation and Research, Bruxelles (BE)

(72) Inventors: Laurent DUEZ, Bruxelles (BE); Antoine CHAUSSINAND, Bruxelles (BE); Jean-François COING, Bruxelles (BE); Serge DUPONT, Bruxelles (BE)

(73) Assignee: Plastic Omnium Advanced Innovation and Research, Bruxelles (BE)

(21) Appl. No.: 18/580,521

(22) PCT Filed: Jul. 22, 2022
(86) PCT No.: PCT/EP2022/070704

§ 371 Date: Jan. 18, 2024

(30) Foreign Application Priority Data
Jul. 23, 2021 (LU) 102848

(51) Int. Cl. B29C 49/20; B29C 49/04; B29L 31/00; B60K 15/03

(52) U.S. Cl. CPC B29C 49/20; B29C 49/04; B29C 2049/2013; B29C 2049/2052; B29C 2049/206; B29C 2049/2065; B29C 2049/2073; B29K 2023/06; B29L 2031/7172; B60K 2015/03032; B60K 15/03177

(57) ABSTRACT

A component for a plastic tank for a motor vehicle, said component being suitable for being inserted into a parison during a manufacture of the plastic tank for the motor vehicle. The component has at least one dimension, in at least one plane perpendicular to a direction of extrusion of the parison, which is substantially equal to or greater than a minimum distance between two opposing points located on a solid inner wall of the parison in said at least one perpendicular plane. The component includes a frame containing a first deflection means including at least one surface suitable for coming into contact with and guiding a travel of the parison when the component is inserted into the parison.

The invention relates to the technical field of plastic tanks for a motor vehicle. More particularly, the invention relates to a component intended to be inserted into a plastic tank for a motor vehicle.

The invention also relates to a method for manufacturing a plastic tank for a motor vehicle. Conventionally, plastic tanks for a motor vehicle are obtained by extrusion blow molding of a parison. During the manufacture of these tanks, devices such as anti-noise baffles or anti-slosh baffles, internal reinforcement elements, valves, ventilation or liquid lines, temperature, level or quality sensors are introduced into the parison with a view to being inserted into the final tank.

One major problem linked to the insertion of these devices into the parison is the limitation of their size. Indeed, it is always sought to avoid contact between the devices and the parison before blow molding the latter with a view to obtaining the plastic tank. Indeed, direct contact between the parison and one of the devices is likely to cause production defects of the tanks, or even tears of the parison.

Various solutions have been proposed in order to solve this problem, more particularly when the parison is provided in the form of a tubular structure. The first solution consists of increasing the size of the extrusion head so as to increase the inner circumference of the tube-shaped parison and thus the space available for inserting the devices. However, the use of a larger extrusion head leads to a greater amount of plastic being used to produce the tank, especially due to greater amounts of plastic spillage or waste.

Alternatively, document JP3179841 discloses a mechanism for stretching the parison before inserting the devices making it possible to increase the space available for inserting the devices. However, this increase is localized only to the points of the parison that are accessible to said mechanism.

Document DE102014221567 proposes introducing, during the formation of the parison, a hollow cylinder under the nozzle head, so that the molten plastic is poured onto the outer surface of the cylinder to form the parison. The devices are inserted into the hollow cylinder, which is therefore positioned between the devices and the parison, while the parison is inserted around the devices. The hollow cylinder is removed after the parison has been formed.

The invention aims in particular to overcome these disadvantages of the prior art.

More specifically, one aim of the invention, in at least one of its embodiments, is to provide a component for a plastic tank for a motor vehicle, said component being suitable for being inserted into a parison during the manufacture of the plastic tank for a motor vehicle.

Another aim of the invention, in at least one of its embodiments, is to implement a method for manufacturing a plastic tank for a motor vehicle.

The invention, in at least one of its embodiments, further aims to provide a plastic tank for a motor vehicle.

In accordance with one particular embodiment, the invention relates to a component for a plastic tank for a motor vehicle.

According to the invention, such a component is suitable for being inserted into a parison during the manufacture of the plastic tank for a motor vehicle, the component having at least one dimension, in at least one plane perpendicular to the direction of extrusion of the parison, which is substantially equal to or greater than the minimum distance between two opposing points located on an inner wall of the parison in said at least one perpendicular plane, and the component comprises a frame comprising a first deflection means comprising at least one surface suitable for coming into contact with and guiding the travel of the parison when the component is inserted into the parison.

The general principle of the invention is based on the use of a component comprising a first deflection means comprising at least one surface suitable for coming into contact with and guiding the travel of the parison when the component is inserted into the parison, said first deflection means being a slide for example.

Thus, the invention is based on an entirely novel and inventive approach of placing the component inserted into the parison in contact with the latter. The component comprising at least one surface suitable for coming into contact with and guiding the travel of the parison when the latter is inserted into the parison makes it possible to reduce the distance between the parison and the component, which makes it possible to reduce the scrap rate. The use of such a component also makes it possible to avoid increasing the size of the extrusion head for a component having at least one dimension close to the minimum distance between two opposing points located on an inner wall of the parison, for example at least one dimension close to the inside diameter of a tubular parison.

It is understood that the inner wall of the parison is preferably solid, so that the wall of the parison is made to cover the component, or to be fit around the component. Thus, the component has a dimension in a plane perpendicular to the direction of extrusion of the parison, which is substantially equal to or greater than the minimum distance between two opposing points located on an inner wall of the parison in the perpendicular plane, without however passing through the parison. In other words, no opening is made in the parison between the extrusion and the blow molding.

The expression “a surface suitable for coming into contact with and guiding the travel of the parison” is understood to refer to the fact that the surface, by coming into contact with the parison, only guides the travel of the latter without causing damage such as tears for example.

It will be noted that the minimum distance between two opposing points located on an inner wall of the parison is considered at the outlet of the extruder, before blow molding, that is to say at the end of extrusion, or at least when part of the parison has exited the extruder, for example when 40%, or even 60% of the final length of the parison is formed. The comparison with the dimension of the component is therefore carried out before any modification of the dimension of the parison, during for example before pre-blow molding or blow molding.

Advantageously, the first deflection means is located offset from the frame.

The expression “located offset from the frame” is understood to refer to the fact that the first deflection means is located on the outer periphery of the frame.

Thus, a first deflection means located offset from the frame allows better distribution of the mechanical stresses induced on the component by better securing between the frame and the first deflection means due to the location of the latter.

According to a preferred embodiment, the component for a plastic tank for a motor vehicle is such that the first deflection means comprises at least two surfaces suitable for coming into contact with and guiding the travel of the parison when the component is inserted into the parison, preferentially said at least two surfaces are located opposite one another with respect to the frame.

Thus, a first deflection means comprising at least two surfaces suitable for coming into contact with and guiding the travel of the parison allows better control of the guiding of the travel of the parison. It is also advantageous for said at least two surfaces to be located opposite one another on the frame, such an arrangement making it possible to obtain a better distribution of the stresses to which the component is subjected during its insertion into the parison.

According to a preferred embodiment of the previous embodiment, the component for a plastic tank for a motor vehicle is such that the at least two surfaces suitable for coming into contact with and guiding the travel of the parison have areas for contact with the parison that are substantially equal.

Thus, two surfaces suitable for coming into contact with and guiding the travel of the parison having areas for contact with the parison that are substantially equal make it possible to apply to the component mechanical stresses of the same order of magnitude for each surface.

According to one variant of the invention, the component for a plastic tank for a motor vehicle is such that the first deflection means has, on all or part of its surface suitable for coming into contact with and guiding the travel of the parison, a curved shape facing the frame.

Thus, a curved shape makes it possible to reduce the risk of tearing the parison. Preferentially, the first deflection means has a shape having a first end such that the component has, at this first end, in at least one plane perpendicular to the direction of extrusion of the parison, a dimension smaller than the minimum distance between two opposing points located on an inner wall of the parison into which it must be inserted, the size of the component increasing according to a slope comprised between 20° and 40° by separating the surface of the first deflection means facing the parison with respect to the frame. Such a slope makes it possible to obtain low friction of the parison on the first deflection means. The slope comprised between 20° and 40° is maintained until the maximum dimension of the component corresponding to a second end of the first deflection means is obtained. The second end of the first deflection means has a rounded shape to prevent tearing of the parison, preferentially the first end of the first deflection means has a rounded shape also.

According to a preferred embodiment, the component for a plastic tank for a motor vehicle is such that the first deflection means comprises at least two surfaces suitable for coming into contact with and guiding the travel of the parison, each of the surfaces having, on all or part, a curved shape facing the frame.

According to a preferred embodiment, the component for a plastic tank for a motor vehicle is such that it comprises a second deflection means including a surface suitable for coming into contact with and guiding the travel of the parison when the component is inserted into the parison.

Thus, the presence on the frame of at least two deflection means makes it possible to better control the guiding of the parison with respect to the frame supporting them.

It is understood that the frame is part of the component, especially when the manufacture is completed. In other words, the frame with the deflection means is part of the component, it is intended to remain in the tank once its manufacture is completed.

According to one embodiment, external deflection means are provided outside the frame, for example on insertion means (such as an insertion rod) for inserting the component into the parison, intended to be removed from the tank after the blow molding step. These external deflection means may be in combination with or an alternative to the presence of a first deflection means provided on the frame of the component.

According to a preferred variant, the component for a plastic tank for a motor vehicle is such that the second deflection means is located offset from the frame.

According to a preferred variant, the component for a plastic tank for a motor vehicle is such that the first and the second deflection means are located opposite one another with respect to the frame.

Thus, the presence on the frame of at least two deflection means located opposite one another with respect to the frame makes it possible to better control and distribute the mechanical stresses induced on the frame.

According to a preferred variant, the component for a plastic tank for a motor vehicle is such that the frame comprises at least one device selected from an internal reinforcement element, an anti-noise baffle or anti-slosh baffle, a valve, a ventilation or liquid line, a temperature sensor, a level sensor or a quality sensor.

According to a preferred variant of the previous embodiment, the component for a plastic tank is such that the frame comprises at least one internal reinforcement element, said internal reinforcement element being suitable for securing at least two walls of the plastic tank for motor vehicles, preferably two opposing walls of the plastic tank for a motor vehicle.

The expression “said internal reinforcement element being suitable for securing at least two walls of the tank” is understood to refer to the fact that the internal reinforcement element allows a connection between two walls of the tank. Part or all of the internal reinforcement element is therefore intended to be in contact with the liquid contained in the tank based upon the amount of liquid contained. The internal reinforcement element preferentially comprises at its opposing ends areas suitable for being welded to the parison and therefore to the walls of the tank.

According to a preferred variant of the two previous embodiments, the component is such that the greatest distance between the median plane of the frame and a plane parallel to the median plane and comprising the surface suitable for coming into contact with and guiding the travel of the parison of the first deflection means is substantially equal to the distance between the median plane of the frame and the outer surface of the at least one device furthest from the median plane of the frame. In the case of an internal reinforcement element, the first deflection means has a dimension substantially equal to the length of the internal reinforcement element, said dimension of the first deflection means considered being located in the same plane as that of the length of the internal reinforcement element. The at least one device is located near the first deflection means on the frame.

Thus, such dimensions allow the first deflection means to have a shield effect, preventing direct contact between the at least one device and the parison. This also applies to the second deflection means.

The expression “median plane of the frame” is understood to refer to the plane that is located in the middle of the frame in the axis of the direction of extrusion.

According to one alternative to the previous embodiment, the component is such that the greatest distance between the median plane of the frame and a plane parallel to the median plane and comprising the surface suitable for coming into contact with and guiding the travel of the parison of the first deflection means is substantially less than the distance between the median plane of the frame and the outer surface of the device furthest from the median plane of the frame. Said outer surface of the device furthest from the median plane of the frame considered being that facing the parison during the insertion of the component into the latter. In the case of an internal reinforcement element, the first deflection means has a dimension substantially less than the length of the internal reinforcement element, said dimension of the first deflection means considered being located in the same plane as that of the length of the internal reinforcement element. The at least one device is located near the first deflection means on the frame

Thus, such an embodiment enables a reduction in the mass of the component. This also applies to the second deflection means.

According to a preferred embodiment, the component for a plastic tank for a motor vehicle is such that the first deflection means is based on a material having a melting temperature that is greater than the temperature of the parison at the outlet of the extrusion head. The second deflection means is also based on a material having a melting temperature that is greater than the temperature of the parison at the outlet of the extrusion head.

Thus, such a material makes it possible to obtain better sliding of the parison over the surface of the deflection means by avoiding welding phenomena.

Generally, the surface of the first deflection means is manufactured from a material having a melting temperature greater than that of the parison at the outlet of the extruder, preferably greater than 165° C., more preferably greater than 180° C., or even greater than 200° C. Thus, the risk of the component welding to the walls of the parison during its insertion is reduced. For example, the temperature of a polyethylene parison at the outlet of the extrusion head can reach 200° C. The parison may especially be made of polyethylene and the surface of the first deflection means can be made of a metal, or polyoxymethylene (POM).

According to a preferred embodiment, the component for a plastic tank for a motor vehicle is such that the first deflection means is based on a material having a coefficient of friction less than the coefficient of friction of the material of the parison. Thus, when the parison is made of polyethylene, the surface of the first deflection means is advantageously made of a metal or a plastic, excluding polyethylene and polypropylene.

According to a preferred embodiment, the component for a plastic tank for a motor vehicle is such that the first deflection means and/or the second deflection means and/or the device selected from an internal reinforcement element, an anti-noise baffle or anti-slosh baffle, a valve, a ventilation or liquid line, a temperature sensor, a level sensor or a quality sensor are/is fastened to the frame by “clipping”.

Thus, “clipping” allows easy handling and fastening of the elements that constitute the component.

According to one alternative to the previous embodiment, the component for a plastic tank for a motor vehicle is such that the first deflection means and/or the second deflection means and the frame form(s) an integral structure.

According to a preferred variant, the component for a plastic tank for a motor vehicle is such that the first deflection means and/or the second deflection means has/have rounded edges.

Thus, the presence of rounded edges on the deflection means makes it possible to reduce the risks of tearing the parison.

According to a preferred variant, the component for a plastic tank for a motor vehicle is such that the frame comprises a receiving member suitable for receiving an insertion means such as an insertion rod for example. Said receiving member is advantageously provided in the form of a hole or a blind hole. This receiving member is generally located on the frame opposite the deflection means.

According to a preferred variant, the component for a plastic tank for a motor vehicle is such that the frame comprises a plurality of through-holes. Preferentially, the frame is also provided with stiffening means such as ribs.

Thus, the presence of through-holes in the frame allows for easier movement of the liquid contained in the tank. The presence of stiffening means on the frame allows the latter to better withstand the stresses associated with the insertion of the component into the frame.

The invention also relates to a method for manufacturing a plastic tank for a motor vehicle.

According to one advantageous embodiment, said manufacturing method comprises at least the following steps, preferably in series:
Extruding a parison having an internal section,
Inserting a component according to the invention into the parison.

During the extrusion, the parison is gradually released from the head of the extruder. The parison thus has a free end, that is to say, an end that is no longer engaged in the head of the extruder. It is by this free end that the component is inserted into the parison. “Extruded parison” is understood to mean the part of the parison already formed and removed from the extruder. The parison into which the component is inserted can have a length shorter than the final length of the parison. Indeed, the insertion of the component into the parison can take place before the parison has been entirely extruded.

Advantageously, the manufacturing method is such that at the beginning of the extrusion of the parison, the free end of the parison is at an initial height and, at the end of the extrusion of the parison, the free end of the parison is at a final height, and during the extrusion of the parison, the free end of the parison moves from the initial height to the final height by crossing a distance referred to as the final length of the parison, and the component is inserted into the extruded parison, by the free end, when the free end of the extruded parison has travelled at least 40% of the final length, preferably at least 60% of the final length.

The invention also relates to a plastic tank for a motor vehicle, said tank comprising a component according to the invention.

The invention also relates to a method for inserting into a parison a component as described hereinbefore, for manufacturing a plastic tank for a motor vehicle, wherein:
when starting to insert the component into the parison, the parison comes into contact with the first deflection means, then
the travel of the parison when the component is inserted into the parison is guided by the surface of the first deflection means.

Other features and advantages of the invention will become more clearly apparent on reading the following description of a preferred embodiment, given by way of simple, illustrative and non-limiting example, and from the appended drawings, among which:

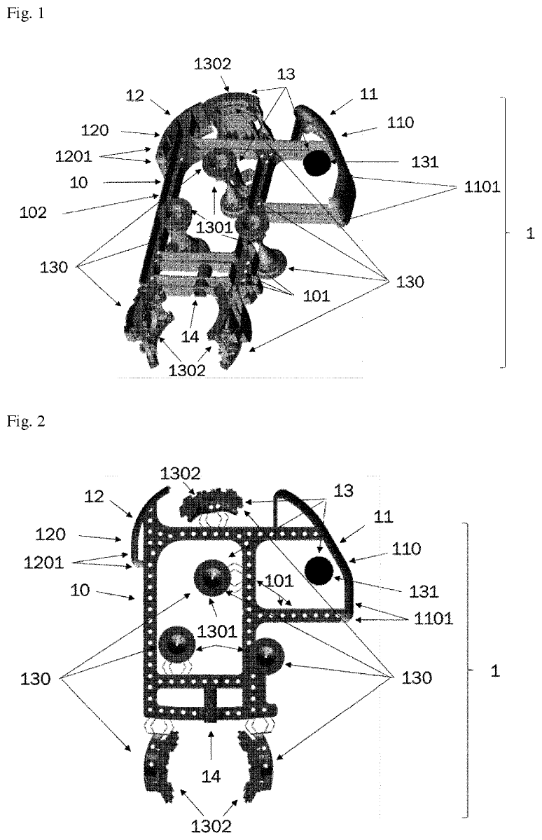

FIG. 1 shows a component for a plastic tank for a motor vehicle according to the invention,

FIG. 2 illustrates the component for a plastic tank for a motor vehicle according to the invention shown in FIG. 1 in a top view,

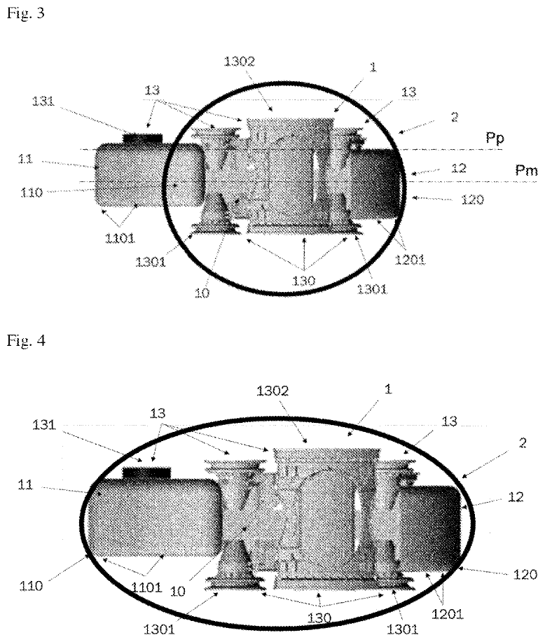

FIGS. 3 and 4 describe the step of inserting into the parison a component according to the invention implemented during the method for manufacturing a plastic tank for a motor vehicle.

Referring to FIG. 1, it shows an embodiment of the component 1 for a plastic tank for a motor vehicle according to the invention. Said component 1 comprises a frame 10 comprising a first deflection means 11 comprising at least one surface 110 suitable for coming into contact with and guiding the travel of the parison when the component 1 is inserted into the parison and a second deflection means 12 including a surface 120 suitable for coming into contact with and guiding the travel of the parison when the component is inserted into the parison. Each of the surfaces 110, 120 has a curved shape facing the frame 10. Said first and second deflection means 11, 12 are located offset from the frame 10 and opposite each other with respect to the frame 10. The first and second deflection means have rounded edges 1101, 1201 making it possible to reduce the risks of tearing the parison during the manufacture of the plastic tank for a motor vehicle. The frame 10 of the component 1 is provided with through-holes 101 as well as stiffening means 102 in the form of ribs. The frame 10 also comprises a plurality of devices 13, including internal reinforcement elements 130 and a valve 131, said internal reinforcement elements 130 being in the form of a diabolo-shaped pillar 1301 or a system 1302 comprising two opposing bracket-shaped ends suitable for being fastened to the parison, said ends being connected by at least two strips. The expression “opposing bracket-shaped ends” is understood to refer to the fact that these two ends are opposite one another and therefore located on either side of the system, but that they also have a shape consisting of two arcs of circle inscribed one inside the other and connected to one another. The frame 10 also includes a receiving member 14 suitable for receiving an insertion means such as an insertion rod for example. Said receiving member 14 is a through-hole. The first and second deflection means 11, 12 and the frame 10 form a one-piece integral structure. Alternatively, the first and second deflection means 11, 12 are fastened to the frame 10 by screwing, welding or clipping. The internal reinforcement elements 130 and the valve 131 are fastened to the frame 10 by clipping. The first and second deflection means 11, 12 are based on a material having a melting temperature that is greater than the temperature of the parison at the outlet of the extrusion head. It is observed that the first and second deflection means 11, 12 are located on the side of the frame 10 of the component 1 intended to first penetrate into the parison during the manufacture of a plastic tank for a motor vehicle.

FIG. 2 shows the component for a plastic tank for a motor vehicle according to the invention shown in FIG. 1 in a top view. The component 1 for a plastic tank for a motor vehicle comprises a frame 10 provided with through-holes. This frame 10 comprises first and second deflection means 11, 12 and also a receiving member 14 suitable for receiving an insertion means such as an insertion rod. The first and second deflection means respectively comprise at least one surface 110, 120 suitable for coming into contact with and guiding the travel of the parison when the component 1 is inserted into the parison. The first and second deflection means 11, 12 have rounded edges 1101, 1201. The frame 10 also includes a plurality of devices 13, including a valve 131 and internal reinforcement elements 130 provided in the form of a diabolo-shaped pillar 1301 or a system 1302 comprising two opposing bracket-shaped ends suitable for being fastened to the parison, said ends being connected by at least two strips. It is observed that the first and second deflection means 11, 12 are located on the side of the frame 10 of the component 1 intended to first penetrate into the parison during the manufacture of a plastic tank for a motor vehicle. Said first and second deflection means are arranged on the frame 10 so as to prevent the parison from coming into contact with the outer surfaces of the devices 13 during the insertion of the component 1 into same.

FIGS. 3 and 4 illustrate the step of inserting into a parison 2 a component 1 according to the invention implemented during the method for manufacturing a plastic tank for a motor vehicle. FIG. 3 shows in a top view in the direction of extrusion, the beginning of the step of inserting the component 1 for a plastic tank for a motor vehicle during the manufacture of said tank. It is observed that the parison 2 of substantially tubular shape comes into contact with the first and second deflection means 11, 12 arranged offset from a frame 10 also comprising devices 13 such as a valve 131 and internal reinforcement elements 130, some of which are provided in the form of a diabolo-shaped pillar 1301 or a system 1302 comprising two opposing bracket-shaped ends suitable for being fastened to the parison, said ends being connected by at least two strips. The first and second deflection means 11, 12 respectively comprise at least one surface 110, 120 coming into contact with and guiding the travel of the parison 2 and have rounded edges 1101, 1201. It is observed that the greatest distance between the median plane Pm of the frame 10 and a plane Pp parallel to the median plane and passing through the surfaces 110, 120 suitable for coming into contact with and guiding the travel of the parison of the first deflection means 11 and second deflection means 12 is substantially less than the distance between the median plane of the frame 10 and the outer surface of the device 13 furthest from the median plane of the frame 10, said outer surface of the device 13 furthest from the median plane of the frame 10 considered being that facing the parison 2 during the insertion of the component 1 into the latter. FIG. 4 illustrates in a top view in the direction of extrusion, the rest of the step of inserting the component 1 for a plastic tank for a motor vehicle during the manufacture of said tank shown in FIG. 3. A deformation of the parison 2 is observed under the effect of contact with the first and second deflection means 11, 12 arranged offset from a frame 10. The travel of the parison 2 is guided by the surfaces 110, 120 of the first deflection means 11 and second deflection means 12, respectively, the latter 11, 12 having rounded edges 1101, 1201. The presence of the first and second deflection means 11, 12 makes it possible to prevent the parison from coming into contact with devices 13 located on the frame 10, said devices 13 being a valve 131 and internal reinforcement elements 130, some of which are provided in the form of a diabolo-shaped pillar 1301 or a system 1302 comprising two opposing bracket-shaped ends suitable for being fastened to the parison, said ends being connected by at least two strips.

1. A component for a plastic tank for a motor vehicle, said component being suitable for being inserted into a parison during a manufacture of the plastic tank for the motor vehicle,
the component having at least one dimension, in at least one plane perpendicular to a direction of extrusion of the parison, which is substantially equal to or greater than a minimum distance between two opposing points located on a solid inner wall of the parison in said at least one perpendicular plane, and
the component comprises a frame comprising a first deflection means comprising at least one surface suitable for coming into contact with and guiding a travel of the parison when the component is inserted into the parison.

2. The component for a plastic tank for a motor vehicle according to claim 1, wherein the first deflection means is located offset from the frame.

3. The component for a plastic tank for a motor vehicle according to claim 1, wherein the first deflection means comprises at least two surfaces suitable for coming into contact with and guiding the travel of the parison when the component is inserted into the parison.

4. The component for a plastic tank for a motor vehicle according to claim 3, wherein the at least two surfaces suitable for coming into contact with and guiding the travel of the parison have areas for contact with the parison that are substantially equal.

5. The component for a plastic tank for a motor vehicle according to claim 1, wherein the first deflection means has, on all or part of its surface suitable for coming into contact with and guiding the travel of the parison, a curved shape facing the frame.

6. The component for a plastic tank for a motor vehicle according to claim 5, wherein the first deflection means comprises at least two surfaces suitable for coming into contact with and guiding the travel of the parison, each of the surfaces having, on all or part, a curved shape facing the frame.

7. The component for a plastic tank for a motor vehicle according to claim 1, wherein a size of the component increases according to a slope comprised between 20° and 40° by separating the surface of the first deflection means facing the parison with respect to the frame.

8. The component for a plastic tank for a motor vehicle according to claim 1, further comprising a second deflection means including a surface suitable for coming into contact with and guiding the travel of the parison when the component is inserted into the parison.

9. The component for a plastic tank for a motor vehicle according to claim 8, wherein the second deflection means is located offset from the frame.

10. The component for a plastic tank for a motor vehicle according to claim 8, wherein the first and second deflection means are located opposite one another with respect to the frame.

11. The component for a plastic tank for a motor vehicle according to claim 1, wherein the frame comprises at least one device selected from an internal reinforcement element, an anti-noise baffle or anti-slosh baffle, a valve, a ventilation or liquid line, a temperature sensor, a level sensor and a quality sensor.

12. The component for a plastic tank for a motor vehicle according to claim 11, wherein the frame comprises at least one internal reinforcement element, said at least one internal reinforcement element being suitable for securing at least two walls of the plastic tank for a motor vehicle.

13. The component for a plastic tank for a motor vehicle according to claim 11, wherein a distance between the frame and the surface suitable for coming into contact with and guiding the travel of the parison of the first deflection means is substantially equal to a distance between the frame and an outer surface of the at least one device furthest from the frame.

14. The component for a plastic tank for a motor vehicle according to claim 1, wherein the first deflection means is based on a material having a melting temperature that is greater than a temperature of the parison at an outlet of an extrusion head.

15. The component for a plastic tank for a motor vehicle according to claim 8, wherein at least one of the first deflection means, the second deflection means and a device selected from an internal reinforcement element, an anti-noise baffle or anti-slosh baffle, a valve, a ventilation or liquid line, a temperature sensor, a level sensor and a quality sensor are fastened to the frame by “clipping”.

16. The component for a plastic tank for a motor vehicle according to claim 8, wherein the first deflection means and/or the second deflection means have rounded edges.

17. The component for a plastic tank for a motor vehicle according to claim 1, wherein the frame comprises a receiving member suitable for receiving an insertion means.

18. The component for a plastic tank for a motor vehicle according to claim 1, wherein the frame comprises a plurality of through-holes.

19. A method for manufacturing a plastic tank for a motor vehicle, comprising in series:
extruding a parison having an internal section and a free end; and
inserting into the extruded parison, by the free end, the component according to claim 1.

20. The method for manufacturing a plastic tank for a motor vehicle according to claim 19, wherein
at a beginning of the extruding the parison, the free end of the parison is at an initial height and, at an end of the extruding the parison, the free end of the parison is at a final height,
wherein, during the extruding the parison, the free end of the parison moves from the initial height to the final height by crossing a distance referred to as the final length of the parison and,
wherein, the component is inserted into the extruded parison, by the free end, when the free end of the extruded parison has travelled at least 40% of the final length of the parison.

21. A plastic tank for a motor vehicle, said tank comprising the component according to claim 1.

22. A method for inserting into the parison the component according to claim 1, wherein:
when starting to insert the component into the parison, the parison comes into contact with the first deflection means, then
the travel of the parison when the component is inserted into the parison is guided by the surface of the first deflection means.
